(19) United States
(12) Patent Application Publication
(10) Pub. No.: US 2007/0241929 A1
(43) Pub. Date: Oct. 18, 2007

(54) MODULAR REMOTE CONTROL DEVICE

(75) Inventor: Oscar MARCHETTO, Oderzo (IT)

Correspondence Address: KATTEN MUCHIN ROSENMAN LLP, 575 MADISON AVENUE, NEW YORK, NY, 10022-2585, US

(73) Assignee: NICE SPA, Oderzo (IT)

(21) Appl. No.: 11/758,758

(22) Filed: Jun. 6, 2007

(30) Foreign Application Priority Data
Dec. 9, 2005 (EP) PCT/EP05/56642
Dec. 17, 2004 (IT) TV2004A000153

(51) Int. Cl. G08C 19/00

(52) U.S. Cl. 340/825.72; 340/5.64; 340/5.7; 341/176; 340/825.56; 455/128; D14/218

(57) ABSTRACT

A modular remote control device (10) is described, said remote control device comprising at least one transmission unit (20a; 20b; 20c; 20d; 20e; 20f), provided with at least one pushbutton (30), and a support (40a; 40b; 40c; 40d) for said at least one unit (20a; 20b; 20c; 20d; 20e; 20f), said at least one unit (20a; 20b; 20c; 20d; 20e; 20f) being removably housed with interference inside a seat (44a; 44b; 44c) with corresponding dimensions formed in a surface (42a, 42b, 42c) of said support, so as to allow said at least one unit to be interchangeable with said support.

The present invention relates to a modular remote control device. Below reference will be made, for the sake of simplicity, to the particular case of automated systems for gates, shutters and the like, but obviously the invention also embraces other areas.

In the last few years automated systems for the home, such as gates, shutters, Venetian blinds, roll-up awnings, entrance doors and garage doors, have become widespread. All of these automated systems are now equipped with remote control devices which operate by means of infrared rays or radio waves via which the user can control operation, as required.

Various types of remote control devices exist, but principally they are divided into portable or wall-mounted remote control devices. The first type are small in size such that they may be easily held in one hand, while the second type are fixed to a wall. The first type have a limited number of pushbuttons for a limited number of functions generally from 1 to 4 pushbuttons so that their size may be kept small), while the second type may have a greater number of pushbuttons (a keypad) so as to have a greater number of functions.

Often the second type of remote control device may be incorporated in other devices such as a light switch or a control unit or may comprise controls for managing the automated system. Obviously, these remote control devices, after being fixed to a wall or incorporated in another device, cannot be replaced easily and quickly as required, or in keeping with the user's taste, since this requires the assistance of specialized personnel at a considerable cost.

Moreover, owing to the varied nature of the applications for automated systems gates, access doors, shutters, blinds, garage doors, awnings, etc.), it is required to use numerous portable or wall-mounted remote control devices, resulting in high purchase costs and difficulty as regards management by the user.

The remote control devices for automated systems hitherto have also become “furnishing complements”. In fact, particular attention is focused on ergonomics and design and, like all articles which come under the sway of fashion, they are subject to frequent review or restyling. Users who wish to replace their own remote control with a newly designed remote control must replace, where possible, the entire remote control unit (this depends also on whether or not the new remote control is compatible with the old receiving section).

This gives rise to the need to provide an automated system with an associated “universal” remote control device which can be easily adapted to the abovementioned requirements, in particular which can be easily adapted by the user to the style of their own home, shop or office premises so that, where possible, the user does not have to purchase complete remote control units which are different from each other.

The main object of the present invention is to provide a group of remote control devices for automated systems which does not have the disadvantages of the state of the art.

This and other objects are achieved with a modular remote control device comprising at least one transmission unit, provided with at least one pushbutton, and a support for said at least one unit, said at least one unit being removably housed with interference inside a seat with corresponding dimensions formed in a surface of said support, so as to allow said at least one unit to be interchangeable with said support.

A main characteristic feature of the invention is therefore the provision of a transmission unit independent of the support, to which it may be fixed using temporary fixing means and from which it may be easily removed for insertion inside another support. Consequently it is sufficient to produce a single electronic transmission module (operating via radio waves, infrared, etc.) to be associated, if necessary, with supports suitable for defining the end use of the remote control device. For this purpose, the transmission unit forms a stand-alone module which incorporates all the functions and the components necessary for correct operation thereof, including an independent power supply, (coded or uncoded) transmission and/or receiving circuits, user interfaces (displays, acoustic signalling devices, etc.).

In an advantageous variant of the remote control device, said unit and said seat have the form of a parallelepiped with a square base, such as to allow the insertion of the unit in the seat with four relative positions. This allows the direction of the transmitter to be adapted to a particular requirement.

Other advantageous variants are listed in the following dependent claims.

The advantages of the invention will emerge more clearly from the following description of an embodiment of the invention, provided by way of a non-limiting example. This description will refer to the accompanying drawings in which:

FIG. 1 shows a transmission unit according to the invention;

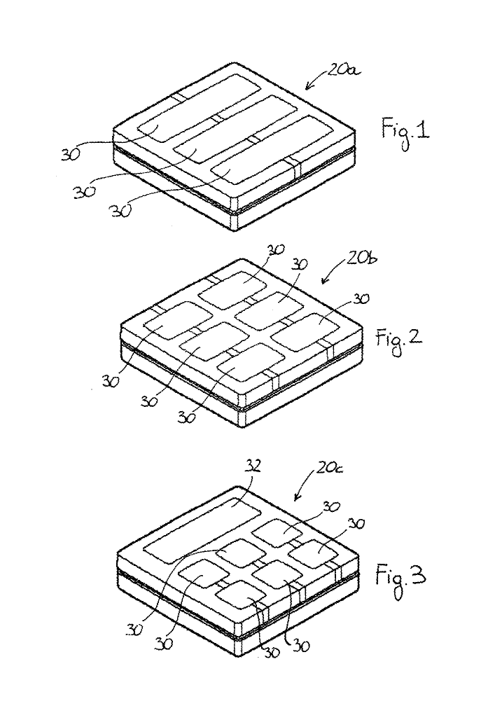

FIG. 2 shows a first variant of the transmission unit according to the invention;

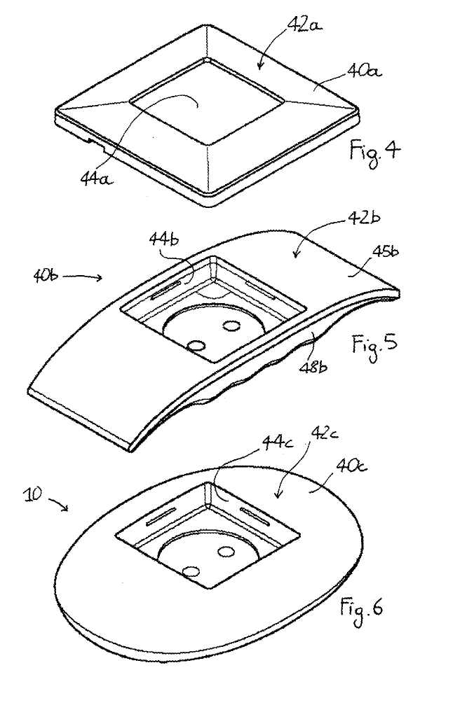

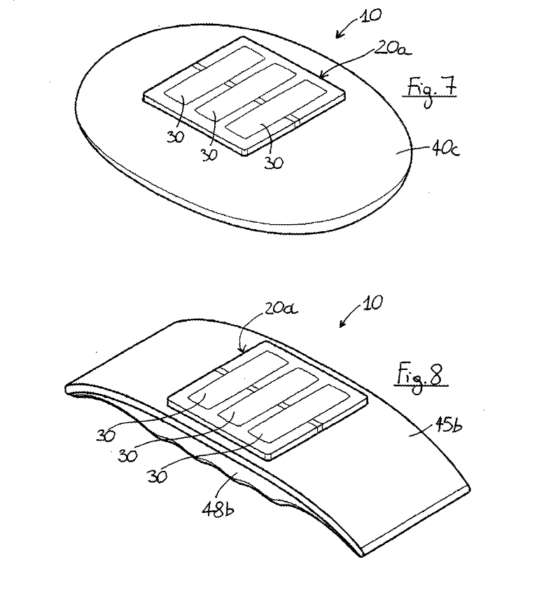

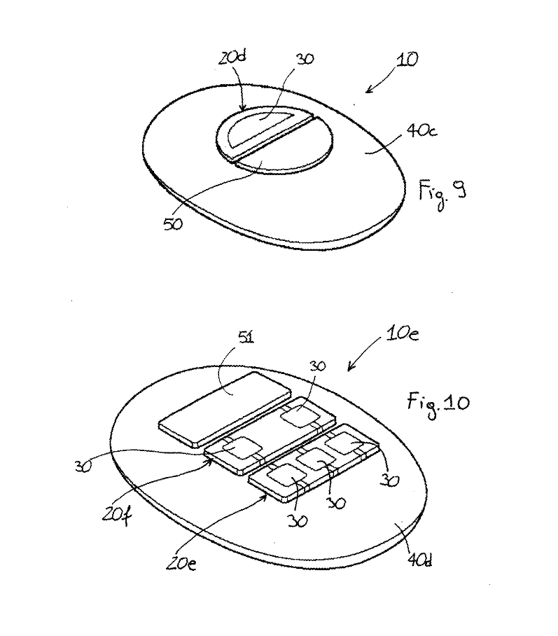

FIG. 3 shows a second variant of the transmission unit according to the invention;

FIG. 4 shows a support for the transmission unit of FIGS. 1-3 according to the invention;

FIG. 5 shows a first variant of the support for the transmission unit of FIGS. 1-3 according to the invention;

FIG. 6 shows a second variant of the support for the transmission unit of FIGS. 1-3 according to the invention;

FIG. 7 shows, combined, the support according to FIG. 6 and a transmission unit according to the invention;

FIG. 8 shows, combined, the support according to FIG. 5 and a transmission unit according to the invention;

FIGS. 9 and 10 show, combined, variants of a support and a transmission unit according to the invention.

In the figures a remote control device according to the invention is generically indicated by 10. It comprises—see FIGS. 1, 2 and 3—one or more transmitting units 20a, 20b, 20c, which are powered by means of a battery (not shown) and provided with pushbuttons 30, and a support—indicated by the generic reference number 40—for said units 20a, 20b, 20c. Below the suffixes “a”, “b”, “c”, etc., will be used to refer to variants of the same element, and pushbuttons of the known type will be indicated generically by 30.

In FIG. 1, the unit 20a has the form of a parallelepiped with a square base and comprises three pushbuttons 30 which are intended to control the functions of an operating system (not shown).

In FIG. 2, the unit 20b again has the form of a parallelepiped with a square base and comprises six pushbuttons 30 which are also intended to control the functions of an operating system.

In FIG. 3, the unit 20c, which has the form of a parallelepiped with a square base, comprises both six pushbuttons 30, which are intended to control the functions of an operating system, and a display 32. The display 32 may be of the liquid crystal, LED segment or dot matrix type.

FIG. 4 shows a support plate 40a which has, on its surface 42a, a seat 44a with dimensions corresponding to those of the units 20a, 20b, 20c. The plate 40a may be fixed to a wall and therefore has special fixing means (not shown—for example holes for wall screws) or may be mounted on known supports, such as mounting plates and/or conventional light sockets.

FIG. 5 shows a grip 40b which has on its surface 42b a seat 44b with dimensions corresponding to those of the units 20a, 20b, 20c. The grip 40b is composed of two parts joined together and arranged on top of each other: an elongated, rigid, upper plate 45b inside which said seat 42b is formed and which is associated with a non-slip, corrugated, soft element 48b which is preferably made of rubber.

FIG. 6 shows a support 40c for a transmission unit 20a, 20b or 20c, which consists of a flattened block with rounded edges suitable for forming when it is engaged with said units 20a,b,c—being housed in a seat 44c with corresponding dimensions in a surface 42a thereof—a remote control unit 10 which can be positioned anywhere in the house (on a table, bedside table, etc.) (see FIG. 7).

Said units 20a,b,c may be engaged, by means of a manual operation, inside the seat 44a of the plate 40a, inside the seat 44b of the grip 40b or inside the seat 44c of the support 40c. The remote control device 10 which is obtained from engagement of the unit 20a in the case of the plate 40a and the grip 40b can be seen in FIG. 6 and FIG. 7.

The assembly consisting of a unit 20a, 20b or 20c and the grip 40b forms a portable remote control device 10. The soft element 48 has the function of making the remote control device 10 comfortable to grip as well as providing a protective support cushion and protecting it in the case of being accidentally dropped.

The square form of the units 20a, b, c in plan view and the corresponding seats 44a, 44b or 44c allows insertion of any one of the units 20a, b, c inside the seat 42a, 44a or 44c in four different positions, at 90° with respect to each other, and therefore orientation of the units 20a, b, c where necessary. From this it can be understood how it is possible to assemble, as required, a remote control device 10, by choosing one of the three units 20a, b, c for the plate 40a or for the grip 40b.

FIG. 9 shows the support 40c for a transmission unit 20d. In this case the unit 20d comprises a single pushbutton 30. The unit 20d has the form of a semi-circle and is inserted inside a corresponding semi-circular seat (not shown) of the support 40c. A second semi-circular part 50 is also present in the support 40c, being also inserted inside a corresponding seat, said part having an aesthetic function (it may display, for example, a logo) and being able to be removed at any time for insertion of another transmission unit, if necessary for operation of different systems.

In FIG. 10 a support 40d for transmission units is again a flattened block with rounded edges, like the support 40c. Two transmission units 20e, f can be engaged inside it so as to form a control unit 10e which can be positioned anywhere inside the house (on a table, a bedside table, etc.). In this case the unit 20e comprises three pushbuttons 30 and the unit 20f comprises two pushbuttons 30. The units 20e and 20f have a rectangular form in plan view and are engaged inside corresponding seats with a rectangular form (not shown) of the support 40d. Similar to FIG. 9, a part 51 is present in the support 40d—being housed in a corresponding rectangular seat of the support 40d (not shown)—without any function, able to be replaced later if necessary with another transmission unit.

It is therefore obvious that it is possible to combine with the support 40d one or more different transmission units such as those indicated by 20e or 20f, it being sufficient to form on said support 40d corresponding seats inside which it is inserted. Different groups of remote control devices are formed in this case, as before, being able to be adapted to any environment at a very low cost since only the support 40, and not the intelligent electronics of the transmission unit, is replaced. It is therefore sufficient to produce separately a single unit 20 and combine it with as many supports 40 as there are final uses to be obtained. There exists, moreover, an economic advantage from a production point of view since a standard part (unit 20) is produced and it is “made up” as required, while according to the state of the art, in order to modify the aesthetic form of the remote control device, it is necessary to modify also the form, dimensions and internal arrangement of the control components. The invention therefore achieves the predefined object.

The support 40a, b, c, d may, for example, be made of plastic materials, wood or metal. It is obvious from the figures that a remote control device 10 may have a transmission unit with different forms (for example round or two half-moons—see Figures) or with several transmitters (one, two, three or more). Moreover, supports 40 and units 20 may be made with forms, colours and functions different from those described, arranging the units 20 on the support 40 also in different layouts. The power supply of the unit 20 may be incorporated in the support 40 and conveyed to the unit 20 via known connections.

It is also possible to use (known) techniques for temporarily fixing the unit 20 to the support 40 (screws, buttons, tabs, tongues, etc.).

1. Modular remote control device (10) comprising at least one transmission unit (20a; 20b; 20c; 20d; 20e; 20f), equipped with at least one pushbutton (30), and a support (40a; 40b; 40c; 40d) for said at least one unit (20a; 20b; 20c; 20d; 20e; 20f), said at least one unit (20a; 20b; 20c; 20d; 20e; 20f) being removably housed with interference inside a seat (44a; 44b; 44c) with corresponding dimensions, formed in a surface (42a, 42b, 42c) of said support, so as to allow said at least one unit to be interchangeable with said support.

2. Remote control device (10) according to claim 1, wherein said at least one unit (20a; 20b; 20c) and said seat (44a; 44b; 44c) have the form of a parallelepiped with a square base.

3. Remote control device (10) according to claim 1, wherein said at least one unit (20a; 20b; 20c) and said seat (44a; 44b; 44c) have a rounded form.

4. Remote control device (10) according to claim 1, wherein said support (40a) is a plate designed to be fixed to a wall.

5. Remote control device (10) according to claim 1, wherein said support (40a) is an elongated rigid plate (42b) inside which said seat (44b) is formed and associated with a non-slip, corrugated, soft element (48).

6. Remote control device (10) according to claim 1, wherein said support (40c) is a flattened block with rounded edges.

7. Remote control device (10) according to claim 1, wherein said unit (20c) comprises a display (32).

8. Remote control device (10) according to claim 1, wherein said at least one transmission unit (20a; 20b; 20c; 20d; 20e; 20f) is housed inside said seat of said support (40a; 40b; 40c; 40d) by means of temporary fixing elements.

9. Remote control device (10) according to claim 1, wherein said unit (20a; 20b; 20c; 20d; 20e; 20f) is of the type comprising an independent power supply.

10. Automated system for gates, shutters or roller blinds generally having a plurality of remote control devices, characterized in that it comprises one or more remote control devices (10) according to claim 1.
